(19) United States
(12) Patent Application Publication
(10) Pub. No.: US 2001/0047585 A1
(43) Pub. Date: Dec. 6, 2001

(54) Method for treating and recycling tires in particular and installation for implementing the same

(76) Inventors: Sanzio Agostinelli, La Ricamarie (FR); Daniel Da Silva, Brioude (FR); Bruno Perrin, Saint Genest Lerpt (FR); Daniel Perrin, Saint Priest en Jarez (FR); Neol Peyron, Le Chambon Feugerolles (FR)

Correspondence Address: HESLIN ROTHENBERG FARLEY & MESITI PC, 5 COLUMBIA CIRCLE, ALBANY, NY, 12203, US

(21) Appl. No.: 09/847,682

(22) Filed: May 2, 2001

Related U.S. Application Data
(63) Continuation of application No. PCT/FR99/02649, filed on Oct. 29, 1999.

(30) Foreign Application Priority Data
Nov. 2, 1998 (FR) FR98/13909
Jun. 4, 1999 (FR) FR99/07376

(51) Int. Cl. B23P 19/04

(52) U.S. Cl. 29/797; 29/426.3; 29/426.4; 29/426.6

(57) ABSTRACT

The invention concerns an installation comprising continuously and successively: at least a station (A) automatically supplying tires; at least a station (B) for simultaneously removing each of the bead cores present in the tire rims; at least a station (C) for gradually crushing, along their circumference, the tires without bead cores; at least a station (D) for transversely cutting the crushed tires to obtain strip sections; at least a station (E) for treating the strip sections to separate the rubber material and the metal plies of the tire body from the running tread of each of the strip sections by reducing the rubber material to rubber crumb; means (12-13-14) for separately recuperating the rubber crumb and the strands of metal plies; the different stations and means are synchronously controlled for automatically and continuously treating and recycling tires.

The invention relates to the technical field of recycling of used rubbers, more especially all types of plastic rubbery materials containing in their thickness a usually metal stiffening reinforcement.

The invention has a particularly advantageous application in the processing of tires from motor vehicles in general, including light vehicles and heavy goods vehicles.

Numerous installations have been proposed for recycling or processing tires, for various applications. The tires are put through operations designed to reduce them to a certain particle size and in some cases to-separate the metal reinforcements from the rubbery material. One such technique which may be cited is the teaching of Patent-WO97/15397.

That patent discloses a technical solution for separating the rubbery materials from the metal reinforcement without the use of cutting means but instead using the metal reinforcement directly as the cutting means. For this purpose, in order to achieve this result, the technical solution concerns an apparatus comprising at least two rows of rollers turning on parallel axes and superimposed in pairs, the tires being engaged between the said rollers for the continuous and successive decohesion of the rubbery material in order to separate it from the metal reinforcement and to produce an aggregate composed of powder, crumb rubber, granulates, resulting from the mixture of rubber and metal particles. The rollers of the top row are driven positively in the same direction of rotation at different linear speeds; the rollers of the bottom row turn in the other direction so as to drive the tire by friction. The set of rollers defines three separate and continuous zones for, in succession, the primary decohesion of the rubbery material, its detachment from the metal reinforcement and removal of the rubbery material from the metal reinforcement, and lastly the separation of the rubbery material from the metal reinforcement to obtain crumb rubber.

The results obtained give complete satisfaction, both in the separation of the rubbery material from the metal reinforcement and in the quality of the crumb powder obtained from the processing of the rubbery material as such.

Using this concept as a basis, the problem addressed by the present invention is that of processing different types of tires continuously and automatically, requiring less labour, which is essentially limited to introducing the tires to be processed.

To solve such a problem a method has now been designed and developed for processing and recycling tires, according to which:

the tires are introduced automatically,

the tires are put through an operation for the simultaneous removal of each of the bead wires of the beads of the said tires,

the tires, now without their bead wires, are put through an operation of crushing them through their circumference to obtain a flattened section,

the resulting flattened section is put through an operation of cutting it transversely into portions of bands of tires,

the portions of bands are continuously put through one or more operations of separating the rubbery material and the metallic plies of the carcass and of the tread band, reducing the said rubbery material to crumb rubber, and

the crumb rubber and the strands of metallic plies are recovered separately.

To carry out the method, an installation has been designed and developed which comprises, in continuous succession:

at least one station for the automatic introduction of the tires,

at least one station for simultaneously or otherwise removing each of the bead wires of the beads of the tires,

at least one station for progressively crushing, through their circumference, the tires, now without their bead wires,

at least one station for cutting the crushed tires transversely into portions of bands,

at least one station for processing the portions of bands to separate the rubbery material and the metallic plies of the carcass and of the tread band of each of the portions of the bands, reducing the rubbery material to crumb rubber,

means for recovering the crumb rubber and the strands of metallic plies separately, and

the various stations and means are synchronized so that the tires are processed and recycled automatically.

The installation therefore employs a combination of several work stations, each corresponding to one specific operation to be carried out on the tires. Such a combination enables the continuous and automatic production of crumb rubber on the one hand, and the various components of the whole of the metal reinforcement of the tire, on the other.

The invention is explained below in greater detail with the aid of the accompanying drawings, in which:

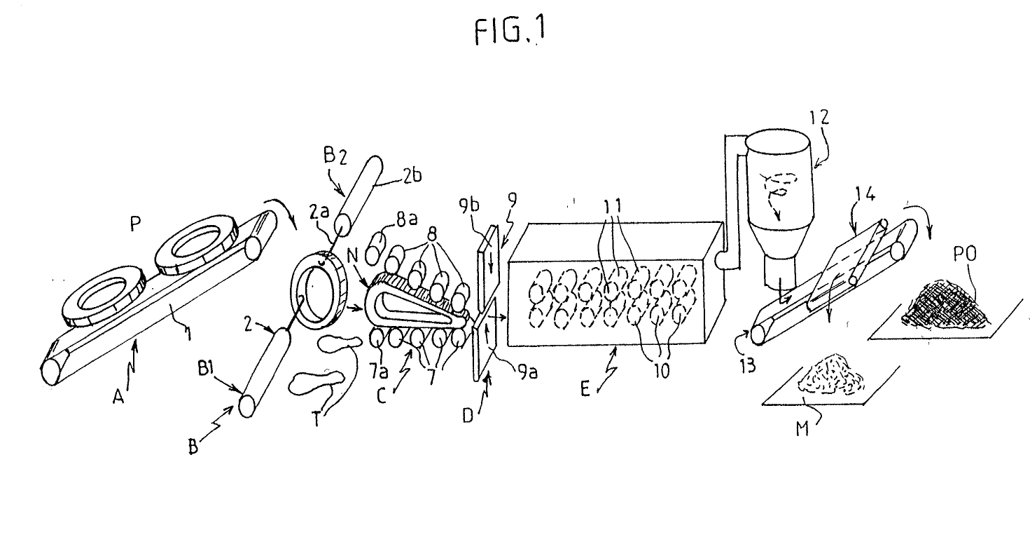

FIG. 1 is a schematic perspective view showing the principle of the whole of the processing installation;

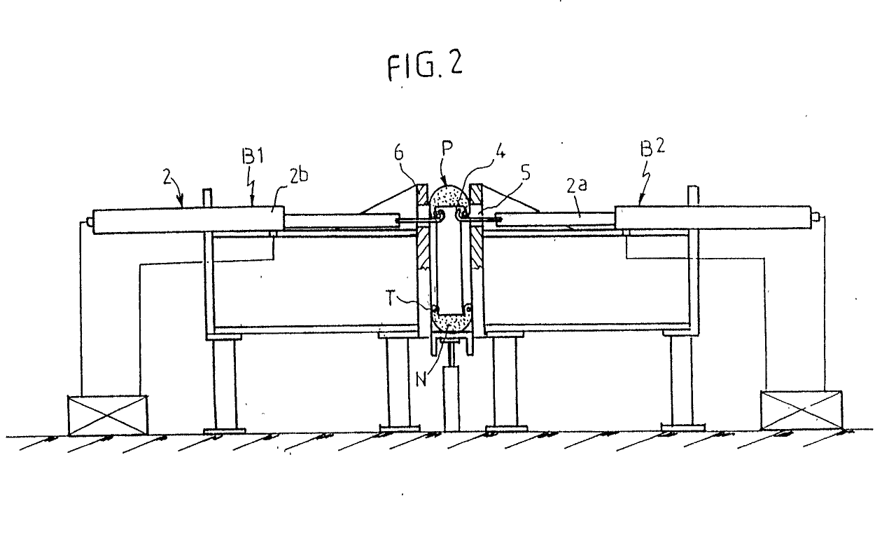

FIG. 2 is a longitudinal section through one of the assemblies for tearing out the bead wire from the tire beads;

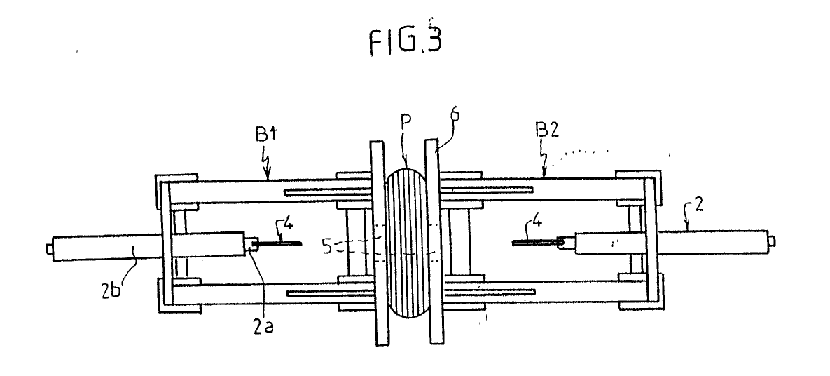

FIG. 3 is a plan view corresponding to FIG. 2;

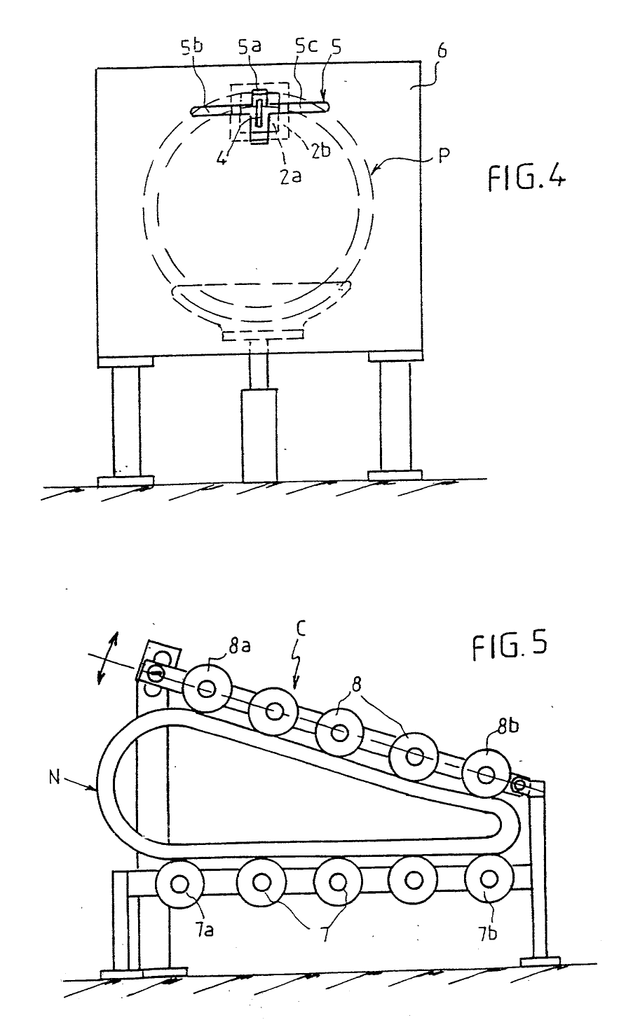

FIG. 4 is a side view corresponding to FIG. 2;

FIG. 5 is a longitudinal section through the tire-crushing station;

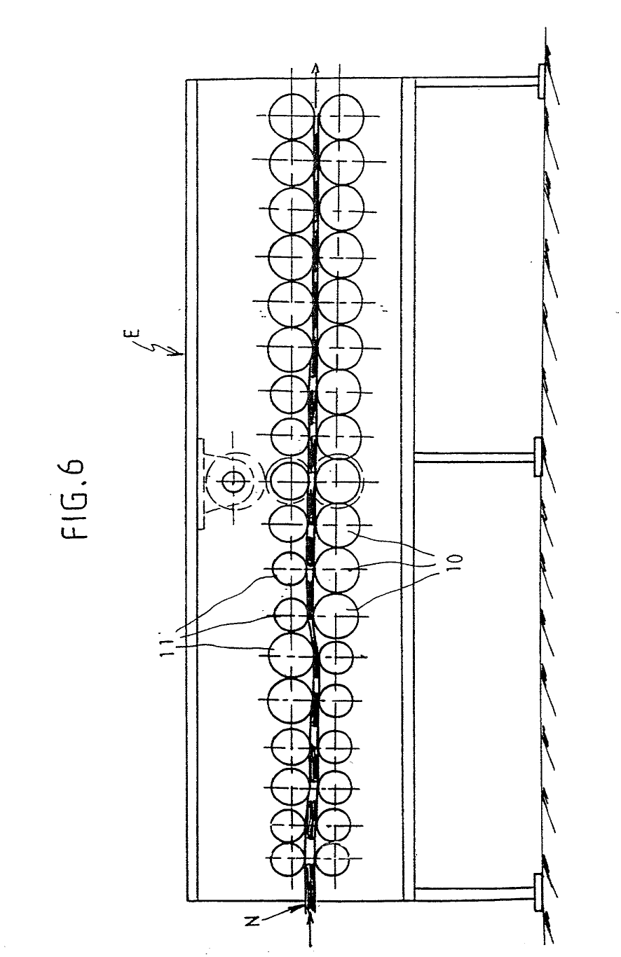

FIG. 6 is a longitudinal section through the station where the rubbery material is separated from the metal reinforcement;

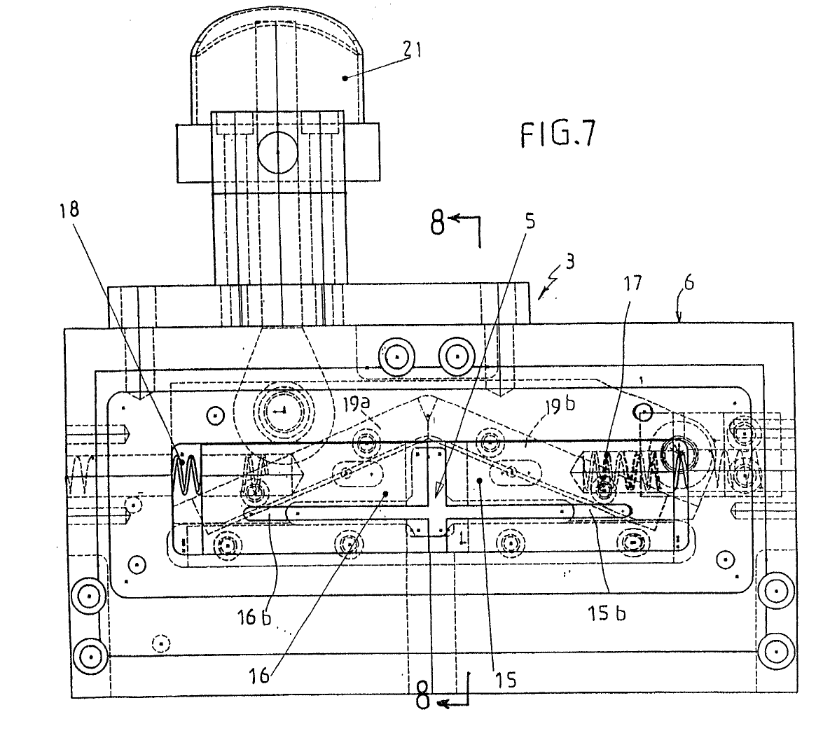

FIG. 7 is a front view of the bead wire-removal assembly;

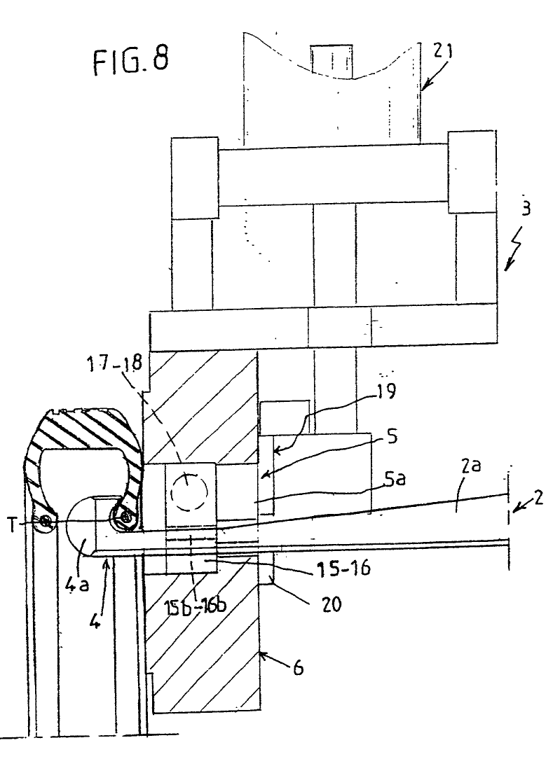

FIG. 8 is a cross section taken on the line 8-8 shown in FIG. 7;

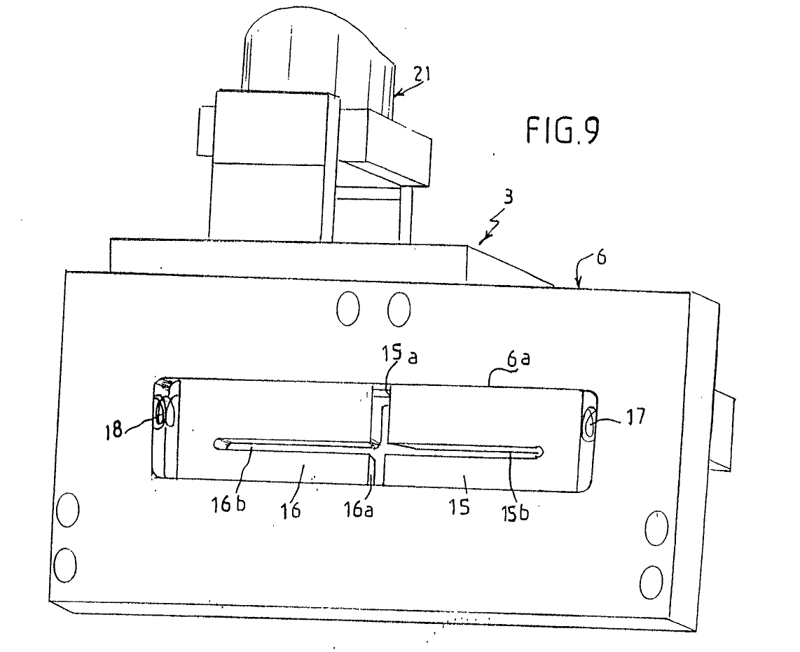

FIG. 9 is a partial perspective view corresponding to FIG. 7, showing the bearing plate;

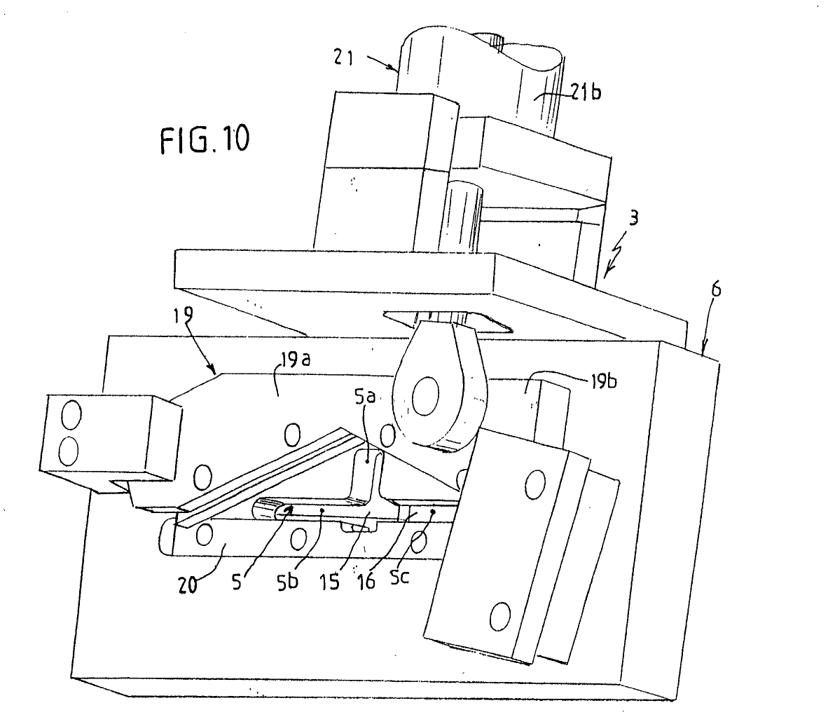

FIG. 10 is a view similar to FIG. 9 viewed from the other side of the bearing plate;

FIG. 11 is a perspective view of one of the sliding blocks;

FIG. 12 is a perspective view of the bead wire-removal member attached to the rod of the removal actuator;

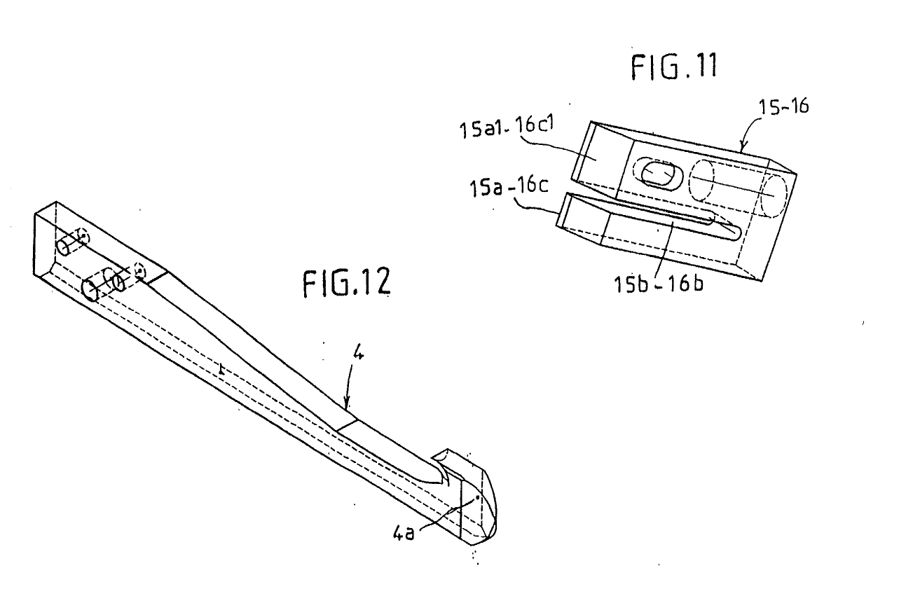

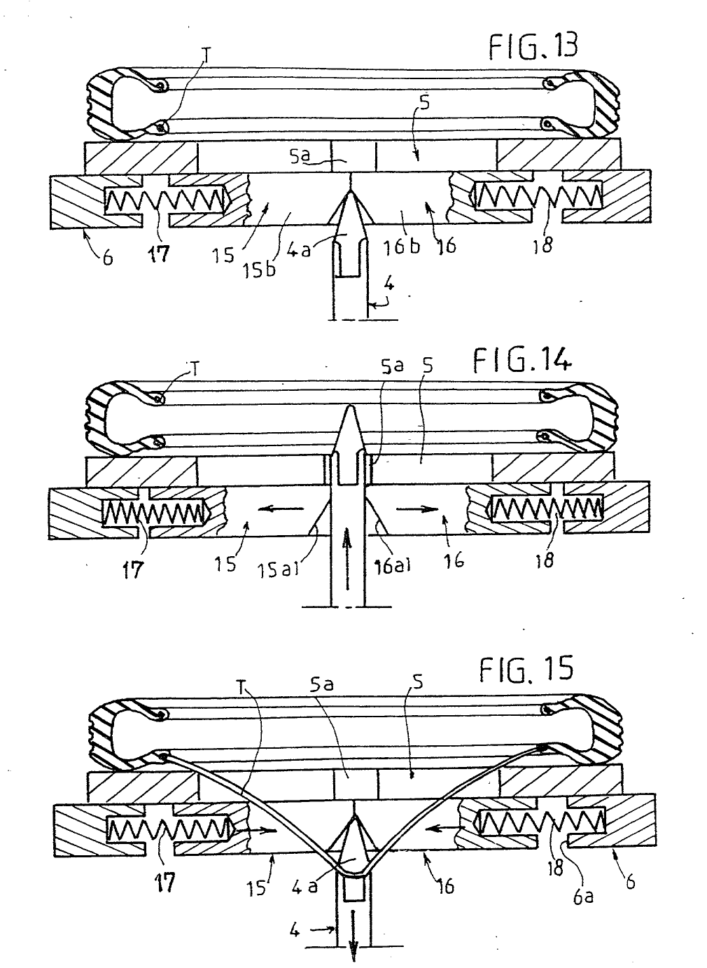

FIGS. 13, 14 and 15 are plan views of a schematic nature showing the principle of operation for the tearing out of the bead wires.

Reference should be made to FIG. 1, which shows the main stations of the tire processing and recycling installation.

It will be useful, for a clearer understanding of the remainder of the description, to begin by noting that a tire consists of three main portions, namely:

a tread band in contact with the ground and comprising a non-skid relief design,

a carcass composed of a metallic reinforcement or ply embedded in rubber,

and a bead or edge containing a bead wire enabling the tire to be mounted on the wheel rim.

The reference (P) denotes the whole of the tire, (N) the metallic ply and (T) the bead wire of the tire bead.

The installation comprises, firstly, a station (A) constructed to position the tires automatically and pass them to the other stations of the installation, particularly a station (B) constructed, as will be indicated in the course of the description, so as simultaneously to tear out each of the bead wires (T) contained inside the tire beads.

Station (A) consists for example of a transfer conveyor belt (1) running upwards at a slope. This transfer belt (1) is of any appropriate known type. Other transfer means are not excluded, e.g. in the form of a lifting plate to feed the tires to station (B).

In the example illustrated, the tires are placed flat on the transfer belt (1) so that they are carried towards station (B) in their rolling direction. Station (B) comprises two identical assemblies (B1) and (B2) arranged opposite each other in symmetrical alignment.

As shown in FIG. 2 in particular, each assembly comprises an actuator (2), the rod (2a) of which is capable of guided linear displacement in a supporting frame (3). The barrel (2b) of the actuator (2) is integral with the frame (3) in a fixed position. The free end of the rod (2a) of the actuator (2) comprises a hook (4) designed to engage, as will be indicated in the course of the description, with the bead of the tire. When the rod (2a) is out, the hook (4) projects through a slot (5) formed in the thickness of a bearing plate (6) mounted at the opposite end of the frame (3) from the barrel (2b) of the actuator and in a vertical plane so as to be perpendicular to the direction of movement of the actuator.

The slot (5) has a profile forming an asymmetrical cross. For this purpose, the slot (5) has a vertical opening (5a) through which the hook (4) passes. This slot (5a) is extended sideways and at right angles to its axis of symmetry by two symmetrically arranged openings (5b) and (5c). The side openings (5b) and (5c) are level with the upper or lower part of the vertical opening (5a). The slot (5) is therefore in a plane perpendicular to the direction of movement of the rod (2a) of the actuator (2).

According to the invention the two assemblies (B1) and (B2) as described are mounted in opposition, symmetrically, so that the rods (2a) of the actuators (2) of both the opposing assemblies are themselves arranged in line, facing one another.

At the outlet end of the feed conveyor (1), the tire is guided towards the station (B), between the two bearing plates (6) of each of the assemblies (B1) and (B2), in order that their beads containing the bead wires (T) can be acted upon by the hooks (4) of the rods (2a) of the actuators (2). For example, the tire may fall under gravity onto a supporting plate connected to a means of displacement in terms of height, to bring the tire in question up to the opposing hooks (4), in order that the latter can then engage with the bead of each sidewall of the tire. These arrangements help to get around all the dimensions.

In this position, with the tire beads caught by the rods (2a) of the actuators (2), a force applied to both actuators causes retraction of the rods (2a), the effect of which is a concomitant tearing out of the bead wires (T) from both beads through the slot (5). In particular, a tensile force exerted by the rods (2a) of the actuators, when their hooks are through the opening (5a), has the effect of forcing the bead wire (T) through the opposing in-line openings (5b) and (5c). The tires themselves slide along the opposing vertical plates (6) of each of the assemblies (B1) and (B2).

The cross-shaped slot (5) works with two opposing profiled parallelepipedal blocks (15 and 16) capable of guided linear sliding in opposite directions against elastic return members (17 and 18), in order to be constantly in a position of contact corresponding to the closure of the vertical slot (Sa). The contacting faces (15a and 16a) of the blocks (15 and 16) are profiled to enable them to be pushed apart by the introduction of the hook means (4) of the actuator (2) corresponding to a thrust force from the actuator rod. Each of the blocks (15 and 16) has a horizontal slot (15b, 16b) over the arms of the horizontal opening of the slot (5) of the plate (6).

The vertical contacting faces (15a, 16a) of each of the blocks (15 and 16) have, over their full height, a slope (15a1, 16a1) to define, in combination, a converging entrance corresponding to a bevelled profile (4a) formed at the tip of the hook means (4) of the rod of the actuator.

Each of the blocks (15 and 16) is capable of sliding in a window (6a) formed in the thickness of the plate (6). Following assembly of the blocks (15 and 16) in the window of the plate (6), the blocks are situated in the same vertical plane as that defined by the bearing face of the plate designed to hold the tire. Each of the blocks (15 and 16) has a recess for housing the corresponding elastic return member (17 and 18) in the form of a spring, the other end of which presses against the vertical edges of the window (6). As indicated, the springs (17 and 18) constantly return the two blocks (15 and 16) to the position in which their profiled faces (15a and 16a) are together, corresponding to the closure of the vertical slot of the plate (6). This position of closure of the vertical opening of the slot (5) corresponds to retraction of the actuator rod (2b).

On the other hand, when a thrust force is applied through the actuator rod in order to hook onto the bead wire of the tire, the effect of the profiled nose (4a) of the hook member (4), and of the converging entrances (15a and 16a) of the blocks (15 and 16), while the thrust force is applied, pushes the blocks apart in two opposite directions and so allows the hook member (4) to pass through the vertical opening of the profiled slot (5).

In this position of projection, the hook element (3) is able to catch onto the tire. The tensile force exerted by the actuator rod has the effect of tearing out the bead wire through the two horizontal aligned slots (15b, 16b) of the blocks (15 and 16) and through the two horizontal openings of the slot (5). As soon as the end of the hook member escapes from the blocks (15 and 16) as the rod retracts, the blocks are automatically moved back until their faces (15a and 16a) are in contact, which position corresponds to closure of the vertical opening of the slot (5) of the plate, thus forcing the bead wire to pass only through the horizontal openings of the blocks and of the plate and so avoiding any risk of jamming. The schematic figures of the drawings illustrate such operation.

Another characteristic is that the opposite face of the plate (6) from that holding the tire, i.e. the face from which the window holding the sliding blocks (15 and 16) is formed, is equipped with a cutting system integral with the frame. This cutting system is constructed so as to cut any remaining strands of the bead wire after it has been torn out and the actuator is at the end of its stroke.

To this end, the cutting system consists of at least one hinged blade (19) controlled by a control member in order to be moved against a fixed blade (20) arranged horizontally in the vicinity of the horizontal opening of the slot of the plate (6). The fixed opposing cutting blade (20) is situated parallel to the horizontal opening of the slot (5). The hinged blade (19) is in two parts (19a and 19b) arranged at an angle to define a V open towards the fixed lower blade (20). The blade (19) is e.g. coupled, in a pivoting manner, to the rod (21a) of an actuator (21) which forms the control member, and the barrel (21b) of which is made integral with part of the machine frame. When the bead wire-removal actuator has completed its stroke, the actuator (21) is engaged to operate the cutting system and, concomitantly, cuts up any strands of the wire (T) that may not have been completely torn out.

In this condition, that is to say after removal of the bead wire (T) from both its beads, the tire is passed automatically to a station (C) constructed so as to crush the tire through its circumference, in order to enable it to undergo the action of a cutting station (D) which will turn it into portions of band.

The crushing station (C) comprises at least two rows of rollers (7) and (8) between which the tires are engaged. The rollers of each of the rows, or of only one of the rows, are driven so that the tire, engaged vertically (or horizontally) between these two rows is fed forward linearly in its rolling direction. Both rows of rollers (7) and (8) are suitably mounted on a supporting frame and define a converging guide space of decreasing section so that the tire is crushed as it advances linearly.

For example, the row of rollers (7) lies in a horizontal plane, while the row of rollers (8) is inclined. The two end rollers (7a) and (8a) at the tire-introduction end are separated by a distance corresponding very approximately to the diameter of the tire to be processed. In order to allow for dimensional differences existing between different tires, the rows (7) and (8) can be installed with the ability to be adjusted relative to each other, in order to modify the spacing between the different rollers. The end rollers (7b) and (8b) are only a small distance apart in order to crush the tire as flat as possible.

It should be noted that the supporting frame containing the crushing rollers (7) and (8) may also include guide rollers disposed perpendicularly on either side of the drive rollers (7) and (8) in order to provide lateral guidance to the tire during its linear advance and crushing.

The various crushing rollers may include asperities.

As indicated, at the outlet from station (C), that is to say after the end rollers (7b) and (8b), the installation comprises the cutting station (D), which is constructed so as to cut the crushed tire transversely into segments of band. This station (D) may consist for example of an assembly acting as a chopper (9) composed of a cutting blade (9a) and an opposing blade (9b) acting vertically or horizontally.

The various portions of band cut up in station (D) are then sent automatically to a station (E) constructed so as to separate the rubbery material and the metallic plies of the carcass and of the tread band of each of the portions of band, and to reduce the rubbery material to crumb rubber. This station for the separation of the rubbery material from the metal reinforcement is advantageously of the type defined in the teaching of patent WO 97/15397.

In essence, the apparatus described in that patent comprises at least two rows of revolving rollers (10) and (11) with parallel axes and superimposed in pairs. The rollers (10) of the first row are driven positively in the same direction of rotation at different linear speeds, while the rollers (11) of the other row turn in the other direction in order to drive the portions of band of tires, engaged flat between the said rollers, by friction. The various portions of band are therefore subjected to a linear driving movement combined with a frictional movement resulting from the pressure generated by the various rollers.

It should be observed that the rollers (10) and (11) as a whole define three separate continuous regions, each corresponding to one function, namely primary decohesion of the rubbery material in order to unstick it from the metal reinforcement, then removal of the rubbery material from the metal reinforcement, and finally separation of the rubbery material from the metal reinforcement to obtain a powder.

The outlet of the separator apparatus (E) as defined is connected to a suction and exhaustion unit of the cyclone type (12) constructed so as to direct the strands of rubbery material and metallic material onto a discharge belt (13). The apparatus (12) is also constructed so as to cool the whole of the separator apparatus (E) and stir the strands of rubbery material and metallic material.

In addition, another characteristic is that the discharge belt (13) is equipped with a magnetic separator (14) for automatically sorting out the strands of metal reinforcement (M) and, at the outlet end of the conveyor (13), the strands of rubbery material in the form of crumb rubber (PO).

Given these arrangements, it is thus possible to process tires continuously with almost no human intervention. The tires have simply to be laid on the feed conveyor (1) and they will then be automatically put through the following continuous cycle of operations:

positioning of the tire between the two bearing plates (6) of the bead wire-removal assemblies (B1) and (B2);

the hooks (4) of the two opposing in-line rods (2a) of the actuators (2) simultaneously tear out the bead wires from each of the beads of the tire through the profiled slots (5) in the plates (6);

the bead wires having now been removed, the tires are then passed automatically between the crushing rollers (7) and (8) of station (C) in order to undergo the shearing action of cutting station (D), to give a plurality of portions of tire band;

at the outlet end of cutting station (D), the portions of band are fed into the separation apparatus of station (E), for separation of the rubbery material from the metallic material; and

at the outlet end of the separator apparatus of station (E), the rubbery and metallic materials are separated and sorted automatically to yield crumb rubber on the one hand and only metallic strands (M) on the other.

The advantages will be clear from the description. In particular, stress is again placed on the entirely automatic nature of the tire-processing operation and the quality of the results obtained.

1. Method for processing and recycling tires, characterized in that:
the tires are introduced automatically,
the tires are put through an operation for the simultaneous removal of each of the bead wires of the beads of the said tires,
the tires, now without their bead wires, are put through an operation of crushing them through their circumference to obtain a flattened section,
the resulting flattened section is put through an operation of cutting it transversely into segments of bands of tires,
the portions of bands are continuously put through operations of separating the rubbery material from the metallic plies of the carcass and of the tread band, reducing the said rubbery material to crumb rubber, and
the crumb rubber and the strands of metallic plies are recovered separately.

2. Installation for carrying out the method according to claim 1, characterized in that it comprises, in continuous succession:
at least one station (A) for the automatic introduction of the tires,
at least one station (B) for simultaneously removing each of the bead wires of the beads of the tires,
at least one station (C) for progressively crushing, through their circumference, the tires, now without their bead wires,
at least one station (D) for cutting the crushed tires transversely into portions of bands,
at least one station (E) for processing the portions of bands to separate the rubbery material and the metallic plies of the carcass and of the tread band of each of the portions of the bands, reducing the rubbery material to crumb rubber,
means (12, 13, 14) for recovering the crumb rubber and the strands of metallic plies separately, and
the various stations and means are synchronized so that the tires are processed and recycled automatically.

3. Installation according to claim 1, characterized in that the station (B) for simultaneously removing each of the bead wires from the tire comprises two identical assemblies (B1) and (B2) arranged opposite each other in symmetrical alignment, the tire being oriented and centred vertically between the said assemblies in order for each of the said bead wires to be subjected to the action of a tearing member (2, 4) belonging to each of the said assemblies.

4. Installation according to claim 3, characterized in that each assembly (B1) and (B2) comprises a pulling member of the actuator type (2), the rod (2a) of which is capable of guided linear displacement in a supporting frame (3) which holds the barrel (2b) of said actuator (2) in a fixed position, the free end of said rod (2a) being equipped with a hook means (4) projecting through a slot (5) in a vertical bearing plate (6) of the frame, the tires being placed vertically with their beads in engagement with the hook means, and the said slot being suitably profiled so that the bead wires can be pulled out through the slot (5) as the rod (2a) retracts.

5. Installation according to claim 4, characterized in that the slot (5) has a profile consisting of two openings forming an asymmetrical cross, defining a horizontal opening and a vertical opening, the horizontal opening being arranged symmetrically on each side of the vertical opening, effectively towards the lower end of the latter.

6. Installation according to claim 4, characterized in that the plate (6) is equipped, in combination with the profiled slot (5), with two opposing profiled parallepipedal blocks (15 and 16) capable of guided linear sliding in opposite directions against elastic return members, in order to be in a position of contact corresponding to the temporary closure of the vertical slot (5a), the contacting faces of the blocks (15 and 16) being profiled to enable them to be pushed apart by the introduction of the hook means (4) of the actuator (2), and the said faces having a horizontal slot (15b, 16b) over the arms of the horizontal opening (5b) of the slot (5) of the plate (6).

7. Machine according to claim 6, characterized in that the contacting faces (15a, 16a) of the sliding blocks (15 and 16) have over their full height a slope to define, in combination, a converging entrance corresponding to a bevelled profile (4a) formed at the tip of the hook means (4) of the actuator (2).

8. Machine according to claim 6, characterized in that the blocks (15 and 16) are capable of sliding in a window (6a) formed in the thickness of the plate (6) so that the said blocks (15 and 16) are situated in the same vertical plane as that defined by the bearing face holding the tires.

9. Machine according to claim 4, characterized in that the opposite face of the plate (6) from that holding the tire is equipped with a cutting system integral with the frame and able to cut any remaining strands of the bead wire after it has been torn out and the actuator is at the end of its-stroke.

10. Machine according to claim 9, characterized in that the cutting system consists of at least one hinged blade (19) connected to a control member (21) to be moved against a fixed blade (20) arranged horizontally in the vicinity of the horizontal opening (5b) of the slot and parallel to this opening, and the hinged blade (19) is in two parts arranged at an angle to define a V open towards the fixed lower blade (20).

11. Installation according to claim 2, characterized in that the station (C) for progressively crushing the tires through their circumference is positioned at the outlet of the bead wire-removal station and comprises a series of superimposed revolving drive rollers (7) and (8) defining an entrance corresponding approximately to the circumference of the tire and a converging guide space of decreasing section so that the tire is crushed as it advances linearly.

12. Installation according to claims 2 and 11, characterized in that the station (D) for cutting the crushed tires comprises, directly at the outlet of the crushing rollers (7b) and (8b), a chopping system (9) which cuts the tire up transversely into the portions of band.

13. Installation according to claim 1, characterized in that the station (E) for processing the portions of band comprises at least two rows of revolving rollers (10) and (11) with parallel axes and superimposed in pairs, the portions being engaged flat between the said rollers which continuously and successively induce decohesion of the rubbery material in order to separate it from the metallic plies and produce a crumb resulting from a mixture of rubber and metallic and/or textile particles, the rollers of the first row being driven positively in the same direction of rotation, at different linear speeds, while the rollers of the other row turn in the other direction in order to drive the portions of tire band by friction.

14. Installation according to claim 2, characterized in that the means for separately recovering the crumb rubber and the strands of metallic ply consist of a suction and exhaustion unit of the cyclone type (12) connected to the outlet of the separation station (E) for directing the rubbery material and the strands onto a discharge unit (13) equipped with a magnetic separator (14) for separating the metal strands from the rubbery material.

15. Installation according to claim 2, characterized in that the various stations (A) (B) (C) (D) (E) preferably are arranged in line and are controlled by a central control unit for the continuous processing of the various tires.
